(19) United States
(12) Patent Application Publication
(10) Pub. No.: US 2020/0043088 A1
(43) Pub. Date: Feb. 6, 2020

(54) Process and system to provide store receipts electronically via an application and direct online banking storage

(71) Applicant: Matthew Lamb, Satellite Beach, FL (US)

(72) Inventor: Matthew Lamb, Satellite Beach, FL (US)

(21) Appl. No.: 16/055,098

(22) Filed: Aug. 5, 2018

(51) Int. Cl. G06Q 40/02; G06Q 20/04

(52) U.S. Cl. CPC G06Q 40/02; G06Q 20/0457

(57) ABSTRACT

A system and computer application that will allow a user's actual original receipt sent directly to the account that purchased the item. This does not allow the store or the bank to only do part of the job, but it allows them to work together to make it easy for customers to have original receipts. The system allows a customer to purchase, receive, and manage receipts without all the run around.

### CROSS-REFERENCES TO RELATED APPLICATIONS (IF ANY)

None

### BACKGROUND

### 1. Field of the Invention

The present invention relates to a process and application to provide electronic receipts, organize and store them.

### 2. Description of Prior Art

Everyone has had a company look up a receipt of a purchase with the buyer only having the card used for the purchase. Most large companies can look up purchases though the card that purchase was made through. There is a way to look up already purchased items and the receipt, but no way to have an electronic receipt linked to the card and sent to their online account access. Places have the option to send email copy a user can print out but it that is not the original or saved to that direct card/account online platform/access.

There is still room for improvement in the art as there is no existing platforms that fit the needs.

### SUMMARY OF THE INVENTION

The current invention is an computer application (app) that will allow the actual original receipt sent directly to the account that purchased the item. This does not allow the store or the bank to only do part of the job, but it allows them to work together to make it easy for customers to have original receipts under their online platform. The current inventions allows a customer to purchase, receive, and manage receipts without all the run around.

The system, in the preferred embodiment, would work like a smartphone application, this product would be available through the respective marketplace for smartphones. The long term focus would allow financial institutes to sent receipts directly to their online consumer's account access.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a receipt being forwarded electronically;

FIG. 3 shows a sample of a login screen;

FIG. 4 shows a sample settings screen;

FIG. 5 shows a sample home page;

FIG. 6 shows a sample categories screen;

FIG. 7 shows a sample accounts screen;

FIG. 8 shows a report screen;

FIG. 9 shows a new report screen; and

FIG. 10 shows a block diagram of the system and application.

### DESCRIPTION OF THE PREFERRED EMBODIMENT

There are a number of significant design features and improvements incorporated within the invention.

The current invention is a system 1 and application that will allow the actual original receipt 40 sent directly to the account that purchased the item.

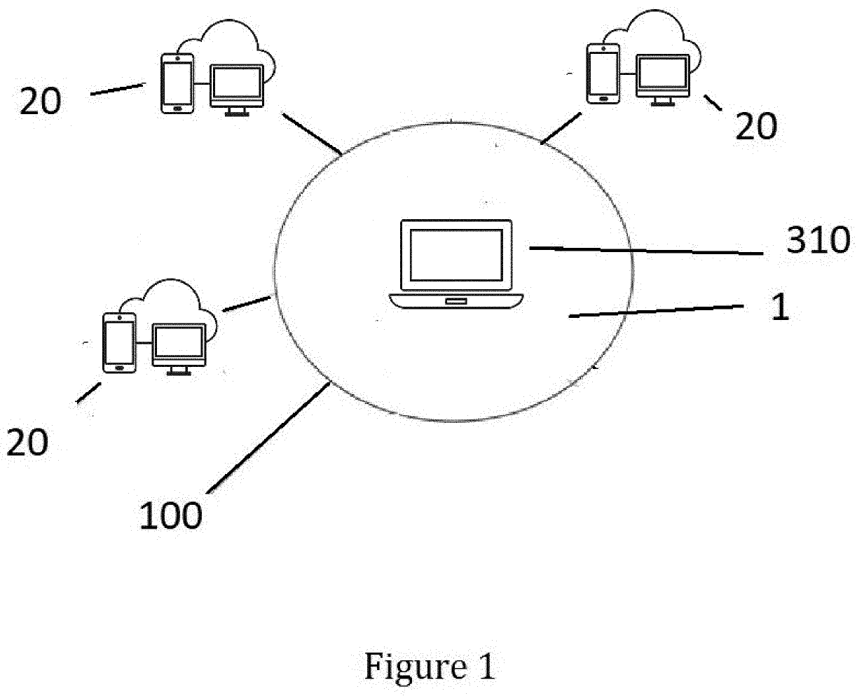

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 20 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

Brief Overview

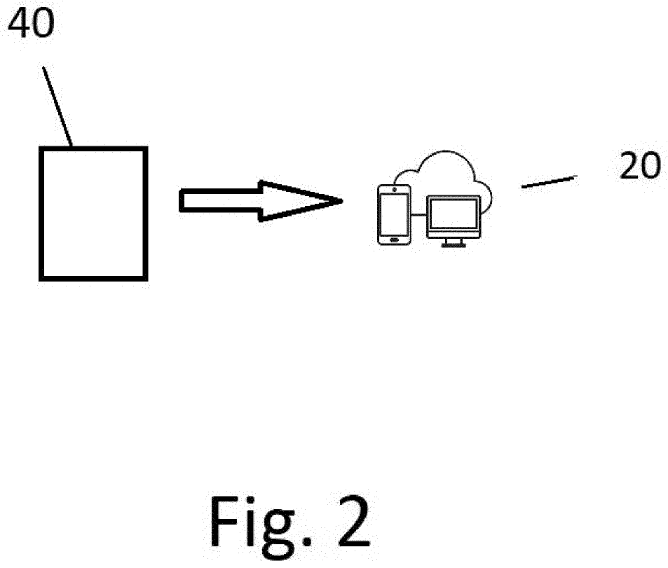

This current invention is a system 1 and application (app) that will forward the actual original receipt 40 sent directly to the account that purchased the item. This does not allow the store or the bank to only do part of the job, but it allows them to work together to make it easy for customers to have original receipts. The system 1 allows a customer to purchase, receive, and manage receipts 40. As shown in FIG. 2, the receipt 40 is sent directly to the computing device 20.

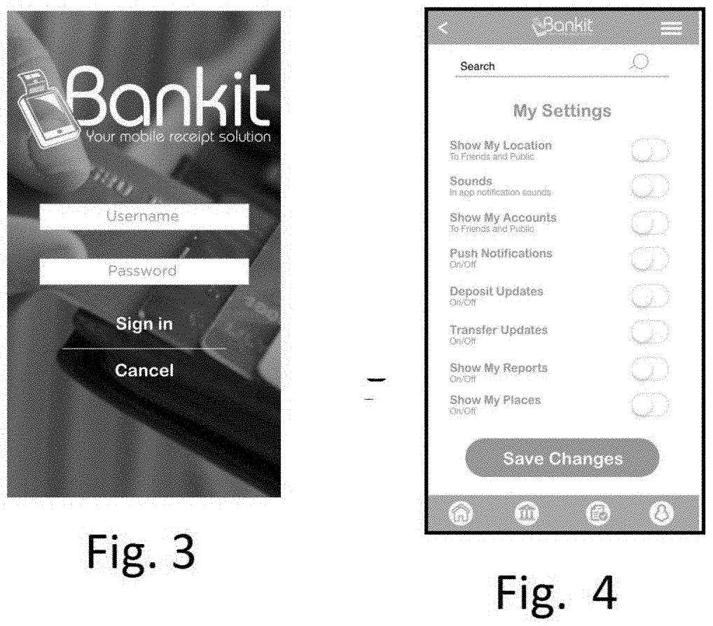

To use the system 1, users would sign-in directly or using social logins as shown in FIG. 3 with the user registering the app,

The system 1 has a setting screen which allows a user to set up the system 1 to which set up their settings such as show my location, sounds, show my accounts, push notification, deposit updates, show my reports and show my places, as shown in FIG. 4. Other settings can be used with the system 1.

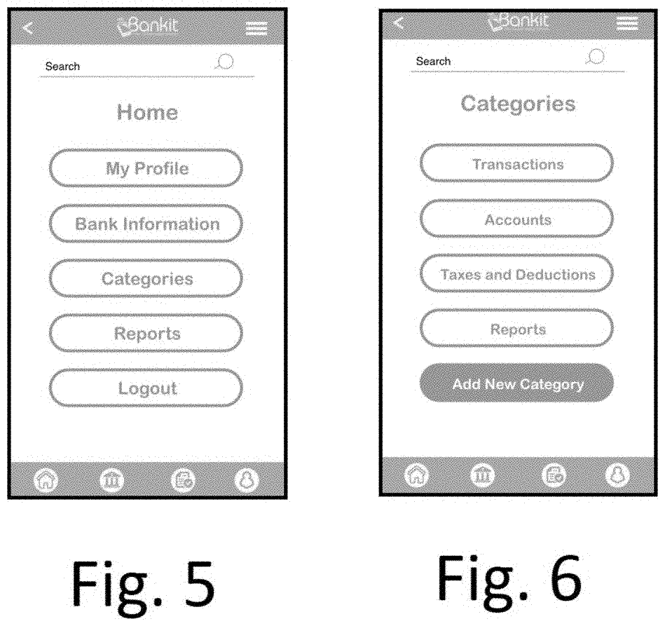

The system 1 will have a home page as shown in FIG. 5. The home page will connect the user to the functions and options of the system such as my profile, bank information, categories, reports and logout.

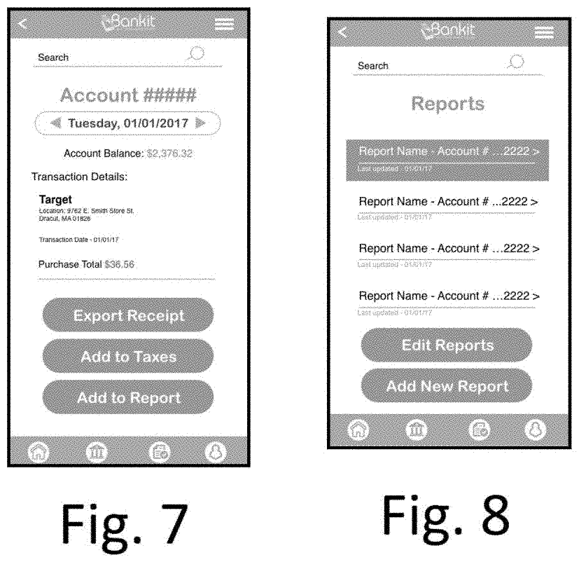

The system 1 will have a categories page as shown in FIG. 6. The categories can be transactions, account, taxes, reports and category.

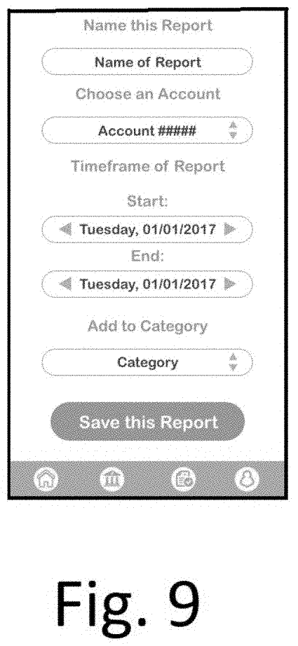

FIG. 7 shows a sample account screen showing the account and account number. The account screen will allow the user to accept a receipt and add it to their tax information and add it to a report. FIG. 8 shows a listing of reports that the user can have on the system 1. It allows the user to edit the reports and add a new report. FIG. 9 shows a create report screen where the user is setting up the accounts and dates that will go into the report.

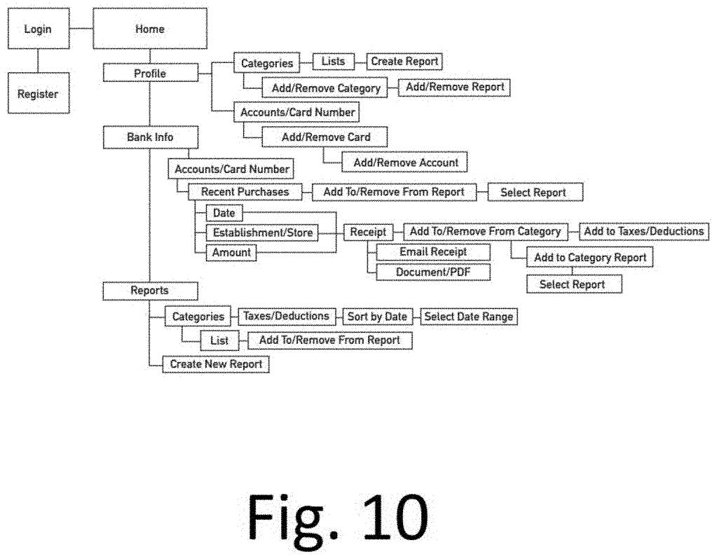

FIG. 10 shows the flow chart of the system 1. The user will Login or Register and Login. The system 1 would bring up the home screen. The home screen has the profile which can consist of the categories, lists and create report. It would also allow the user to sent up the account/card number and to add or remove a card or an account.

The user could go to the bank information which would have the account numbers and the recent purchases. The receipt will be sent by the generator of the receipt to the system. The system will record the receipt to an account based on criteria in the system on which account the receipt should go into.

The user could also see and create reports. There reports can be of any category.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
setting up accounts on the system;
having receipts go directly to a computing device to an account; and
producing reports based on the receipts.

2. A system according to claim 1 having a home screen.

3. A system according to claim 1 having a login screen.

4. A system according to claim 1 having a setting screen.

5. A system according to claim 4 where the setting screen sets one or more settings from a list of location, sounds, show my accounts, push notification, deposit updates, show reports and show places.

6. A system according to claim 1 having the home page will connect to the functions and options of the system such as one or more of my profile, bank information, categories, reports and logout.

7. A system according to claim 1 having a categories page with one or more categories such as transactions, account, taxes, reports and category.

8. A system according to claim 1 having an account screen showing the account and account number.

9. A system according to claim 8 having the account screen will allow the accepting a receipt and add it to their tax information and add it to a report.

9. A system according to claim 1 having a listing of reports.

10. A system according to claim 1 having a create report screen.

11. A system according to claim 1 having the sent up the account number and to add or remove an account.

12. A system according to claim 1 having the record the receipt to an account based on criteria in the system on which account the receipt should go into.

13. A system comprising;
having a system that resides in the non-transitory memory of a computing device;
setting up accounts on the system;
having receipts go directly to a computing device to an account;
producing reports based on the receipts;
having a home screen;
having a login screen;
having a setting screen;
where the setting screen sets one or more settings from a list of location, sounds, show my accounts, push notification, deposit updates, show reports and show places;
having the home page will connect to the functions and options of the system such as one or more of my profile, bank information, categories, reports and logout;
having a categories page with one or more categories such as transactions, account, taxes, reports and category; and
having an account screen showing the account and account number.

14. A system according to claim 13 having the account screen will allow the accepting a receipt and add it to their tax information and add it to a report.

15. A system according to claim 13 having a listing of reports.

16. A system according to claim 13 having a create report screen.

17. A system according to claim 13 having the sent up the account number and to add or remove an account.

18. A system according to claim 13 having the record the receipt to an account based on criteria in the system on which account the receipt should go into.
